(19) United States
(12) Patent Application Publication
(10) Pub. No.: US 2010/0065402 A1
(43) Pub. Date: Mar. 18, 2010

(54) BELT CONVEYOR

(76) Inventors: David Pruett, Canon City, CO (US); Raymond Middlemiss, Canon City, CO (US); Thomas Harding, Canon City, CO (US)

Correspondence Address: KLAAS, LAW, O''MEARA & MALKIN, P.C., 1999 BROADWAY, SUITE 2225, DENVER, CO, 80202, US

(21) Appl. No.: 12/554,725

(22) Filed: Sep. 4, 2009

Related U.S. Application Data
(60) Provisional application No. 61/095,523, filed on Sep. 9, 2008.

(51) Int. Cl. B65G 39/16; B65G 23/04; B65G 15/60

(52) U.S. Cl. 198/617; 198/835

(57) ABSTRACT

A conveyor is disclosed herein. An embodiment of the conveyor comprises an upper side, an under side, a first end, a second end, and a frame comprising a first side and a second side. At least one roller is located in the underside, the at least one roller extends between the frame first side and the frame second side. A belt extends between the first end and the second end, wherein the belt contacts the at least one roller. A bracket connects the first side of the frame to the at least one roller. The bracket comprises a first portion that is pivotally connected to the first side of the frame and a second portion pivotally connected to the roller, the bracket enables the roller to pivot relative to the first side of the frame.

This application is a continuation of patent application Ser. No. 61/095,523, filed on Sep. 9, 2008 for BELT CONVEYOR. This application claims the benefits of the prior application, which is incorporated by reference for all that is disclosed therein.

### BACKGROUND

Conveyors use a belt to convey items between points. The belt moves about two pulleys or rollers located at endpoints of the conveyor. One problem with conveyors is that the belt wanders as it moves. The wandering is typically caused by one edge of the belt being a different length than the opposite edge.

This wandering may cause the belt to move relative to the conveyor, which may cause the belt to wear, tear, or otherwise disable the conveyor. In order to overcome the wandering, conventional conveyors use devices that steer the belt to the correct location. However, these devices may cause extra wear on the belt and require a lot of time to adjust. The devices may also be noisy and may limit the speed in which the belt moves.

### BRIEF DESCRIPTION OF THE DRAWINGS

FIG. 1 is a top perspective view of a conveyor.

FIG. 2 is a top perspective view of the conveyor of FIG. 1 with the belt removed.

FIG. 3 is a bottom perspective view of a portion of the conveyor of FIG. 2.

FIG. 4 is an enlarged view showing the association of a roller to a frame of the conveyor of FIG. 3.

### DETAILED DESCRIPTION

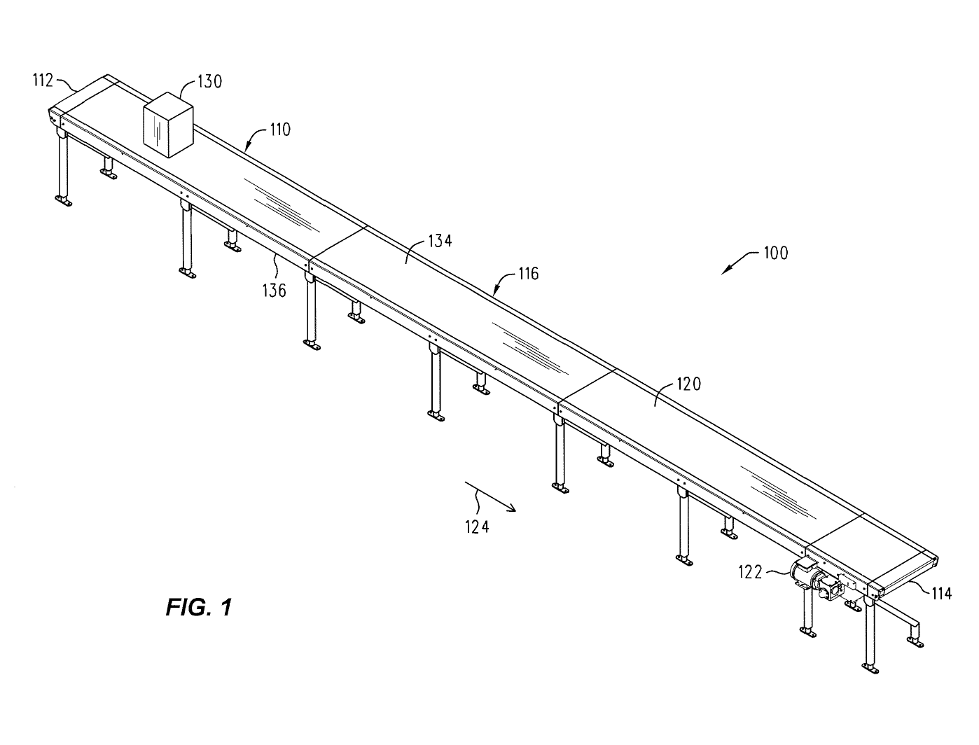

An example of a conveyor 100 is shown in FIG. 1. The conveyor 100 includes a first end 112 and a second end 114. The conveyor 100 has a frame 116 extending between the first end 112 and the second end 114. A continuous belt 120 is able to move relative to the frame 116. When viewed from the top of the conveyor 100, the belt 120 moves in a direction 124. Although, the conveyor 100 may be able to move the belt 120 in an opposite direction. The belt 120 serves to move items, such as the item 130 from the first end 112 to the second end 114. A motor 122 moves the belt 120 in a conventional manner. In the embodiment of the conveyor 100 of FIG. 1, the motor is located proximate the second end 114; however, the motor 122 may be located in other locations and may or may not be attached to the frame 116.

For reference purposes, the conveyor 100 is referred to as having an upper side 134, which is sometimes referred to as a first side, and an underside 136, which is sometimes referred to as a second side. The frame 116 has a support mechanism, not shown in FIG. 1, that supports the belt 120 as it travels on the upper side 134. Gravity causes the belt 120 to sag as the belt 120 travels on the underside 136. The belt path relative to the underside 136 is sometimes referred to as the return or return path of the belt 120. As described in greater detail below, rollers serve to support the belt 120 on the underside 136. The rollers also serve to maintain the belt 120 in a fixed location relative to the frame 116.

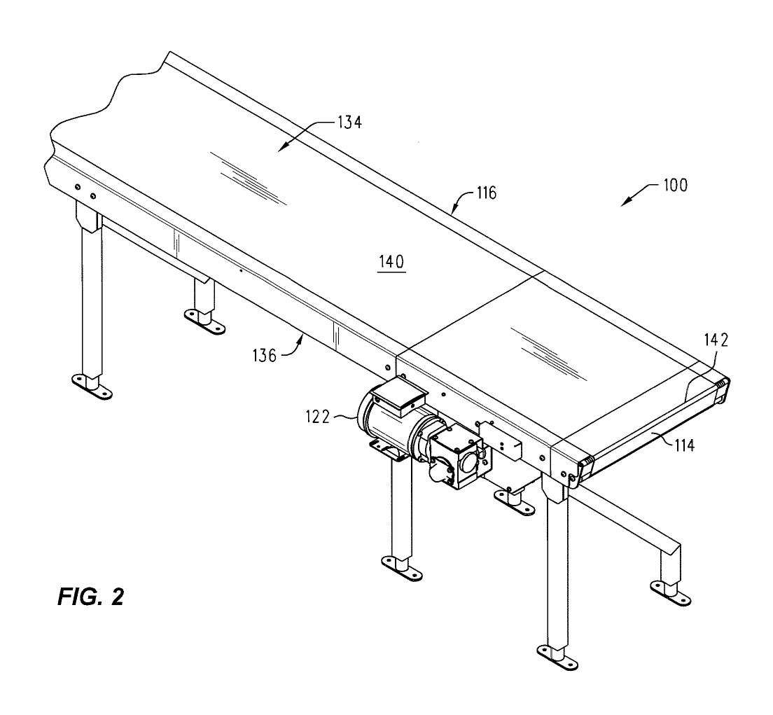

FIG. 2 shows the second end 114 of the conveyor 100 with the belt removed. The upper side 134 of the conveyor 100 has a bed 140 on which the belt slides. In other embodiments, the bed 140 may have rollers or the like located thereon that facilitate the movement of the belt. The end 114 has transition devices that transition the belt from traveling on the upper side 134 to traveling on the underside 136. These transition devices may include rollers, pulleys, and belt tensioning devices.

One problem with conveyors is that the belts and/or the conveyors are not exactly straight. For example, one side of the belt 120, FIG. 1, may be slightly longer than the other side. In other embodiments, the belt 120 may not be perfectly flat and may have a ripple or the like in it. Either condition may be caused by imperfections during manufacture or wear. Because the belt is slightly crooked, the belt wanders as it moves. This wandering may cause the belt to move on, or relative to, the transition devices. In order to overcome the wandering, conventional conveyors use devices that steer the belt to the correct location. However, these devices may cause extra wear on the belt. The devices may also be noisy and may limit the speed in which the belt moves.

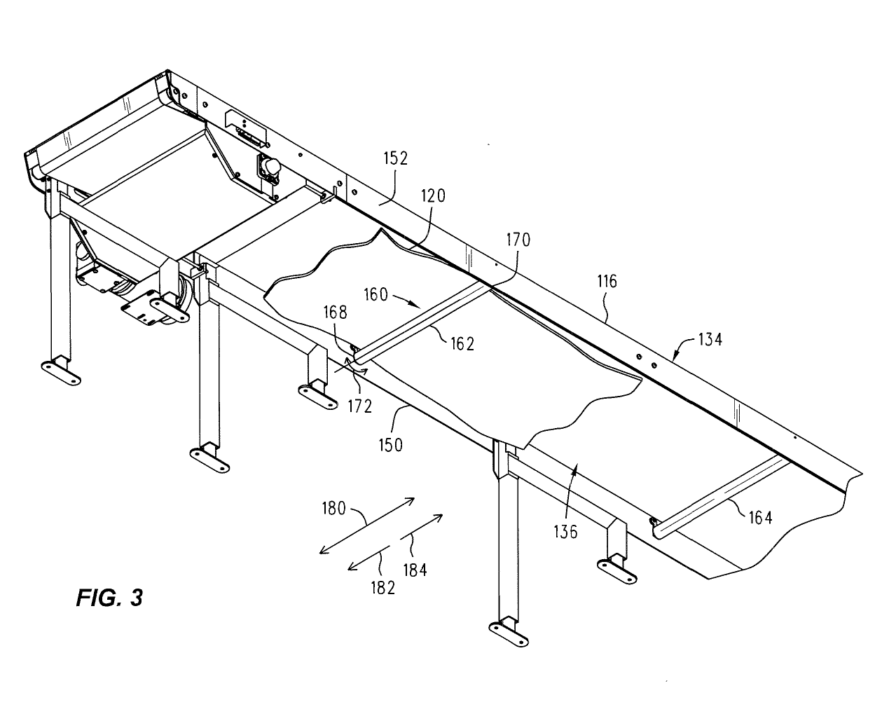

Additional reference is made to FIG. 3, which is a bottom perspective view of the conveyor 100 showing the underside 136. As shown in FIG. 3, the frame 116 has two sides, a first side 150 and a second side 152, wherein the belt 120 is located substantially between the first side 150 and the second side 152. The conveyor 100 described herein uses movable rollers 160 to guide the belt 120 in order to keep the belt 120 from wandering. FIG. 3 shows two rollers 160, which are referred to individually as a first roller 162 and a second roller 164. As shown, the belt 120 lays on and is supported by the rollers 160 when the belt is in the return path. As described below, the rollers 160 are pivotally attached to each side 150, 152 of the frame 116, wherein the pivoting causes the belt 120 to realign should it wander.

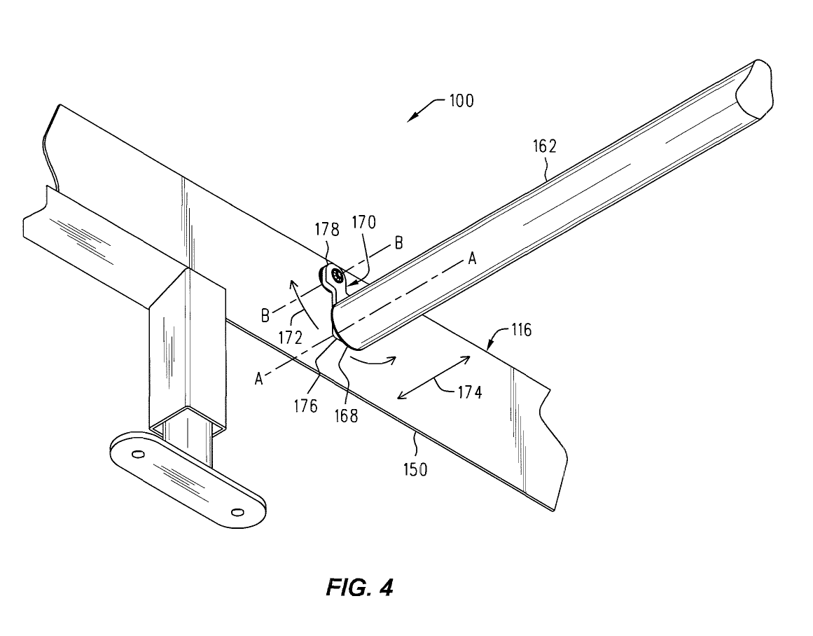

Reference is made to the first roller 162, which is substantially similar to the second roller 164. The first roller 162 has a first end 168 located proximate the first side 150 of the frame 116 and a second end 170 located proximate the second side 152 of the frame 116. The second roller 164 has similar ends. FIG. 4 is an enlarged view of the first end 168 of the first roller 162 and the first side 150 of the frame 116. A bracket 170 serves to connect the first end 168 of the roller 162 to the first side 150 of the frame 116. The second end 170 of the roller 170 has a bracket similar to the bracket 170 connecting the second end 170 to the second side 152 of the frame 116. Thus, the description of the bracket 170 applies to all the brackets connecting the rollers 160 to the frame 116.

The rollers 160 have bearings or the like located proximate their ends. For example, the first roller 162 has bearings or the like located proximate the first end 168 and bearings located proximate the second end 170. The bearings enable the rollers 160 to rotate relative to the brackets 170. It is noted that the bearings have some friction.

The bracket 170 serves to pivotally connect the first end 168 of the first roller 162 to the first side 150 of the frame 116. In summary, the bracket 170 enables the first roller 162 to rotate about an axis AA. In addition, the bracket 170 enables the first roller 162 to swing or pivot in a direction 172 relative to the first side 150 of the frame 116. A first connector portion 176 of the bracket 170 rotatably connects the bracket 170 to the first roller 162 and enables the first roller 162 to rotate about the axis AA. As described above, bearings within the first roller 162 may enable this rotation. The mounting of the first roller 162 to the bracket 170 also enables to the first roller 162 to move slightly along the axis AA in the direction 174. In addition, the first roller 162 may move so that the axis AA is not normal to the bracket 170 while the roller 162 continues to be able to rotate. The movement enables the ends 168, 170, FIG. 3, of the first roller 162 to pivot in different directions as described in greater detail below.

A second connector portion 178 serves to pivotally or rotatably connect the bracket 170 to the first side 150 of the frame 116. A pin or other fastener connects the second connection portion 178 of the bracket 170 to the second side 150 of the frame 116. Therefore, the bracket 170 can rotate in the direction 172 relative to the frame 116.

Having described the conveyor 100, the operation of the conveyor 100 will now be described. In summary, the rollers 160 serve to support the belt 120 on its return path. The pivoting of the ends 168, 170 of the rollers 160 causes the belt 120 to stay on the rollers 160 and in proper alignment with respect to the chassis 116. As stated above, the belt 120 is likely not perfectly straight. For example, one side is typically a little longer than the other side. The imperfections in the belt 120 may be due to wear and heating. The imperfections in the belt 120 may be in the form of ripples in the belt wherein a small section of the belt may have one side that is longer than the other side. These imperfections in the belt 120 cause the belt 120 to wander out of alignment relative to the conveyor 100. As described below, the pivoting of the rollers 160 counters the wandering of the belt 120 and realigns the belt 120.

Referring to FIG. 3, as the belt 120 moves along the return path, it is supported by the rollers 160. The belt 120 may wander along an axis 180 in a first direction 182 or a second direction 184 opposite the first direction. The directions 182, 184 may be substantially normal to the sides 150, 152 of the frame 116. As described above, the wandering is caused by the belt 120 being longer on one side than the other side.

Referring to the first roller 162, when a longer portion of the belt 120 contacts an end 168, 170 of the first roller, more force is exerted on the roller. The increased force increases the friction on the corresponding side of the first roller 162, which reduces its ability to rotate due to friction. This side of the first roller 162 then pivots along the direction 172. The pivoting causes the return path associated with the longer side of the belt 120 to be slightly longer than the other side. Therefore, the pivoting compensates for the different belt length, which maintains the belt 120 in a proper position in the conveyor 100.

The belt correction will now be described with reference to an example. In this example, a portion of the belt 120 corresponding to the first end 168 of the first roller 162 is slightly longer than the other side of the belt 120. As this portion of the belt 120 may appear as a light sag on the side of the belt when this portion is in the return path of the conveyor 100. When the sag contacts the first roller 162, the sag, which is located proximate the first end 168 of the first roller 162 causes additional frictional force to be applied to the first end 168 of the first roller 162. This additional force is greater than the frictional force applied to the second end 170 of the first roller 162. The additional frictional force applied to the first end 168 of the first roller 162 causes the first end 168 of the first roller 162 to pivot in the direction 172. The second end 170 of the first roller 162 does not pivot. Therefore, the return path proximate the first end 168 of the first roller 162 is longer than the return path associated with the second end 170 of the first roller. This longer return path compensations for the ripple in the belt 120 and maintains the belt 120 in proper alignment within the conveyor 100.

What is claimed is:

1. A conveyor comprising:
an upper side;
an under side;
a first end;
a second end;
a frame comprising a first side and a second side;
at least one roller located in said underside, said at least one roller extending between said frame first side and said frame second side;
a belt extending between said first end and said second end, wherein said belt contacts said at least one roller;
a first bracket connecting said first side of said frame to said at least one roller;
said first bracket comprising a first portion that is pivotally connected to said first side of said frame and a second portion pivotally connected to said roller, said first bracket enabling said roller to pivot relative to said first side of said frame.

2. The conveyor of claim 1, wherein said roller has a first end located proximate said first side of said frame and a second end located proximate said second side of said frame, wherein said first bracket enables said first end of said roller to move closer to said upper side than said second end of said roller.

3. The conveyor of claim 1 and further comprising a second bracket, said second bracket comprising a first portion that is pivotally connected to said second side of said frame and a second portion pivotally connected to said roller, said second bracket enabling said roller to pivot relative to said second side of said frame.

4. The conveyor of claim 3, wherein said roller has a first end located proximate said first side of said frame and a second end located proximate said second side of said frame, wherein said second bracket enables said second end of said roller to move closer to said upper side than said first end of said roller.

5. The conveyor of claim 1, wherein said first bracket enables said roller to move in a direction normal to said first side of said frame.

6. The conveyor of claim 1, wherein said first bracket has a motor connected thereto, said motor enabling said first bracket to pivot relative to said first frame.

7. A conveyor comprising:
an upper side;
an under side;
a first end;
a second end;
a frame comprising a first side and a second side;
a roller located in said underside, said roller extending between said frame first side and said frame second side, said roller having a first end located proximate said first side of said frame and a second end located proximate said second side of said frame;
a belt extending between said first end and said second end, wherein said belt contacts said at least one roller;
a first bracket connecting said first side of said frame to said first side of said roller, said first bracket comprising a first portion that is pivotally connected to said first side of said frame and a second portion pivotally connected to said first end of said roller, said first bracket enabling said roller to pivot relative to said first side of said frame; and
a second bracket connecting said second side of said frame to said second side of said roller, said second bracket comprising a first portion that is pivotally connected to said second side of said frame and a second portion pivotally connected to said second end of said roller, said second bracket enabling said roller to pivot relative to said second side of said frame.

8. The conveyor of claim 7, wherein said first bracket and said second bracket enable said roller to move in a direction normal to said first side of said frame.

9. The conveyor of claim 7, wherein said first bracket and said second bracket enable said first end of said roller to move closer to said upper side than said second side of said roller.

10. The conveyor of claim 7, wherein said first bracket has a motor connected thereto, said motor enabling said first bracket to pivot relative to said first frame.

11. A method for aligning a belt used in a conveyor, said conveyor having an upper side and an under side, wherein items are transported by a continuous belt on said upperside and wherein a roller on said underside supports said belt during the return, said method comprising:
supporting said belt using said roller; and
lifting a side of said roller when said belt wanders, said lifting causing said belt to wander perpendicular to the movement of said belt.

12. The method of claim 11, wherein said roller has a first end and a second end, said belt being located between said first end and said second end; and wherein said lifting comprises lifting said first end closer to said upperside than said second end.

13. The method of claim 11, wherein said conveyor comprises a bracket pivotally attaching said roller to a frame associated with said conveyor; and wherein said lifting comprises pivoting an end of said roller by way of said bracket.

14. The method of clam 11 and further comprising sensing wandering of said belt; and wherein said lifting comprises lifting in response to said sensing.
